(19) United States
(12) Patent Application Publication
(10) Pub. No.: US 2011/0136359 A1
(43) Pub. Date: Jun. 9, 2011

(54) GUITAR END PIN JACK PLUG

(76) Inventor: Ronald Derrick Gregg, Hazel Green, AL (US)

(21) Appl. No.: 12/634,238

(22) Filed: Dec. 9, 2009

(51) Int. Cl. H01R 13/44

(52) U.S. Cl. 439/148

(57) ABSTRACT

A guitar end pin jack plug device is described which is mated with an end pin jack while the electrical plug is not mated with the end pin jack, for the purpose of preventing a support strap from coming off of the end pin jack. The present invention has a shaft which is inserted into and is retained by the end pin jack. The present invention also has a head which is of sufficient diameter to prevent the opening in the strap from coming completely off of the end pin jack. The present invention is much simpler than the prior art and is less subject to becoming ineffective over time as it is used and worn as compared to the prior art. While the present invention is described as being used on guitar end pin jacks, it is not limited to use with guitars. The present invention may be used on any article with similar jacks and support straps.

### FIELD OF THE INVENTION

The present invention pertains to the field of strap securing devices. More specifically, the present invention is in the field of devices which help prevent the end of a strap from inadvertently coming off a combination end pin/electrical output jack such as those which are commonly used on guitars and other similar instruments.

### BACKGROUND OF THE DISCLOSURE

Many articles, including but not limited to guitars, have an end pin to which an end of a support strap is normally attached. For many articles, this end pin is a combination end pin/electrical jack (sometimes referred to as an end pin jack). A common construction for such end pin and end pin jacks is for the end pin or end pin jack to have a shoulder which is intended to prevent the strap from inadvertently coming off of the end pin or end pin jack. The end of the support strap will commonly have a hole and slot opening which is sized to allow the shoulder to be inserted through the opening but remain fairly secure against inadvertent removal.

As the article and its support strap are used over a period of time, the hole and slot opening can become worn and somewhat enlarged. This sometimes results in the end pin jack shoulder no longer being a very secure method of attachment for the strap. The enlarged hole and slot opening can easily slip off of the shoulder, especially during period of movement of the article.

For articles with an end pin jack, the occurrence of an inadvertent removal is not likely while an electrical plug is mated with the end pin jack because the body of the electrical plug prevents the strap from coming completely free. When the electrical plug is unmated from the end pin jack, such as when a musician unplugs the audio jack from his guitar in order to move about, there is a significant possibility of the strap inadvertently coming off of the end pin jack.

The prior art offers examples of methods and devices to help secure a strap to an end pin or end pin jack. These methods typically involve installing a locking mechanism onto the end of the strap to secure it to the end pin or end pin jack. In U.S. Pat. No. 6,590,145 to Doiron (2003) such a device is described. Other prior art which requires modifying, adapting, or otherwise connecting to the end of the strap prior to use are disclosed in U.S. Pat. No. 4,271,999 to Stravitz (1981), U.S. Pat. No. 4,993,127 to Mechem et. al. (1991), and U.S. Pat. No. 7,166,789 to Warden (2007).

Other prior art offers devices which are not installed onto the end of the strap but are fastened onto the end pin after the strap has been affixed to the end pin. In U.S. Pat. No. 7,256,337 to Walker (2007) such a device is described which hooks over the end pin after the strap is affixed. Any given embodiment of the Walker device works best for a limited range of end pin shoulder sizes due to the fixed position of the hooks which secure it to the end pin. Even if the Walker device and the end pin sizes are initially properly matched, the size of the opening in the Walker device can become enlarged due to the friction of frequent insertion and removal with a period of use. The design of the Walker device permits its easy inadvertent removal if it is inadvertently hit in an upward direction, especially if the device and the end pin are not properly sized. The walker device has a relatively complex shape which can result in significant manufacturing costs, either for initial tooling, recurring costs, or both.

In U.S. Pat. No. 6,259,009 to Bolo (2001) a device is disclosed which is installed over the end pin after the strap is affixed. The Bolo device has a limited adjustment mechanism which expands the opening to allow insertion of the device onto the end pin. The mechanism is then relaxed to allow the opening to return to its relaxed size. The Bolo device's limited adjustment mechanism requires a reasonably close match to the end pin size. The shape and construction of the Bolo device is relatively complex which can result in significant manufacturing costs, either for initial tooling, recurring costs, or both.

### SUMMARY OF THE DISCLOSURE

The present invention is a device which plugs into an end pin jack while there is no electrical plug mated with the end pin jack, for the purpose of preventing a support strap from coming off of the end pin jack. The present invention has a shaft and a head. The shaft is inserted into the electrical jack of the end pin jack, the said shaft being sized and shaped to permit insertion but with adequate retention force to prevent easy accidental removal. The head is sized large enough to prevent the hole and slot opening in the end of the strap from inadvertently slipping past the head while the article is being moved about.

### BRIEF DESCRIPTION OF THE DRAWINGS

FIG. 1 shows one embodiment of the present invention plugged into an end pin jack of a guitar.

FIG. 2 shows an end pin jack of a guitar and a typical mating electrical plug.

FIG. 3 shows an end pin jack of a guitar with an electrical plug mated with the end pin jack.

FIG. 4A shows a typical strap with a hole and slot opening for connecting to an end pin.

FIG. 4B shows a typical strap with a hole and slot opening affixed onto a typical end pin jack with no electrical plug mated with the end pin jack.

FIG. 4C shows a typical strap with a hole and slot opening affixed onto a typical end pin jack with the present invention mated with the end pin jack.

FIG. 5A shows one simple embodiment of the present invention.

FIG. 5B shows another embodiment of the present invention.

FIG. 5C shows another embodiment of the present invention.

### DETAILED DESCRIPTION

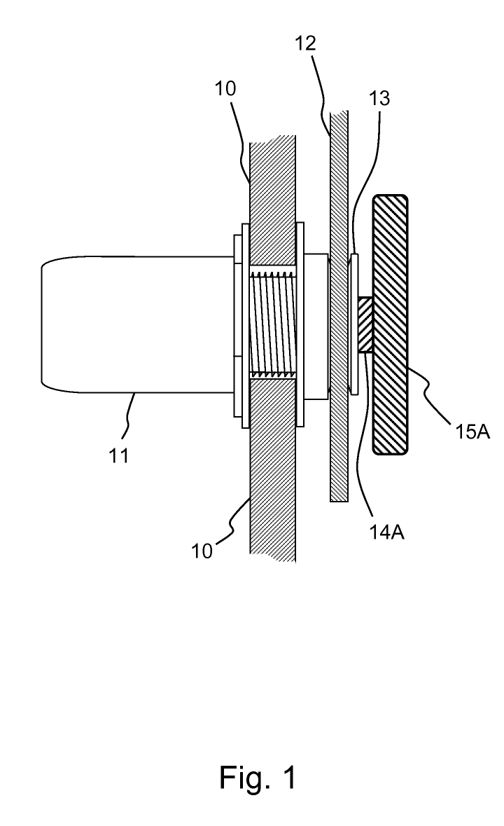

As shown in FIG. 1, one embodiment of the present invention mates with an end pin jack. The end pin jack 11 is mounted through a hole in the guitar body 10. A support strap 12 is attached to the end pin jack. The support strap 12 is somewhat restrained from coming of the end pin jack off by the end pin jack shoulder 13. The present invention has a shaft 14A which mates with the end pin jack by being inserted similar to the normal insertion of an electrical plug. The head 15A of the present invention is sufficiently large to prevent the hole and slot opening of the support strap from coming completely off if the opening should inadvertently slip off of the end pin shoulder. The size and shape of the head 15A can vary significantly for different embodiments of the present invention.

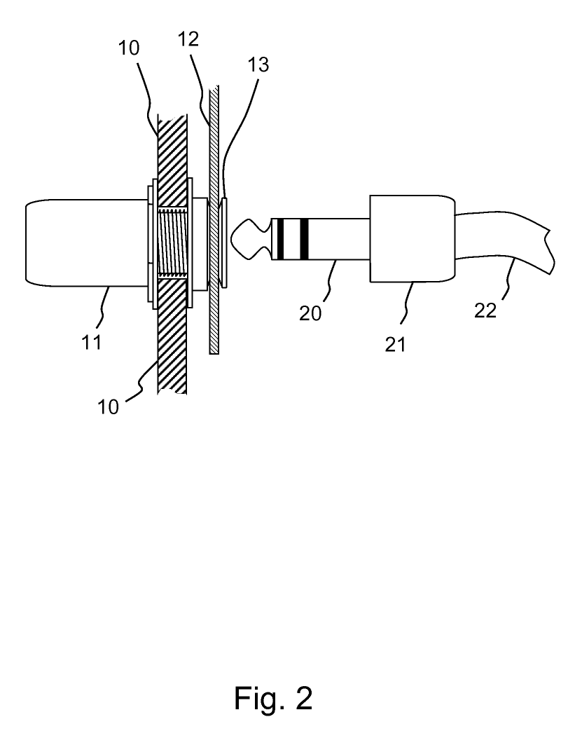

FIG. 2 shows an end pin jack 11 mounted to a guitar body 10. Also shown is a typical mating electrical plug 20 with a plug body 21 and plug cord 22. A support strap 12 is affixed to the end pin jack 11 and held in place only by the end pin shoulder 13. The support strap 12 is somewhat restrained from coming of the end pin jack off by the end pin jack shoulder 13, but there are no other mechanisms in place for preventing the inadvertent removal of the support strap 12.

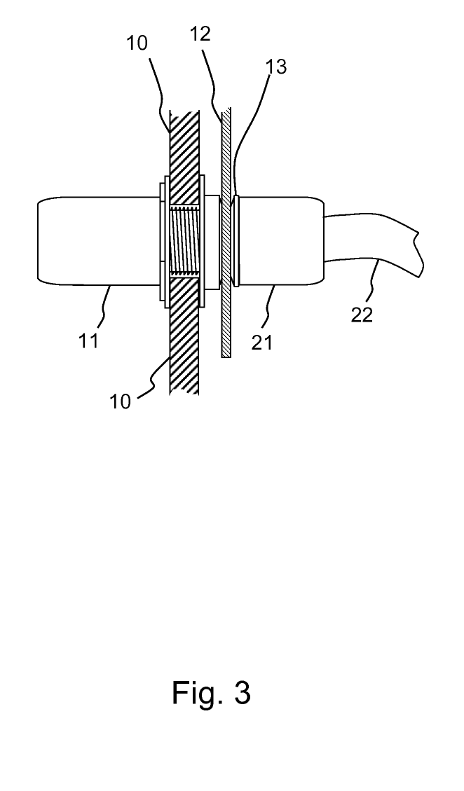

FIG. 3 shows an end pin jack 11 mounted to a guitar body 10. Also shown is a typically mated plug body 21 and plug cord 22 in position once the electrical plug 20 of FIG. 2 is fully mated with the end pin jack 11. A support strap 12 is affixed to the end pin jack 11 and held in place by the end pin shoulder 13. The support strap 12 is somewhat restrained from coming of the end pin jack off by the end pin jack shoulder 13, but even if it comes off of the end pin jack it is still supporting the guitar by way of the plug body 21 or plug cord 22.

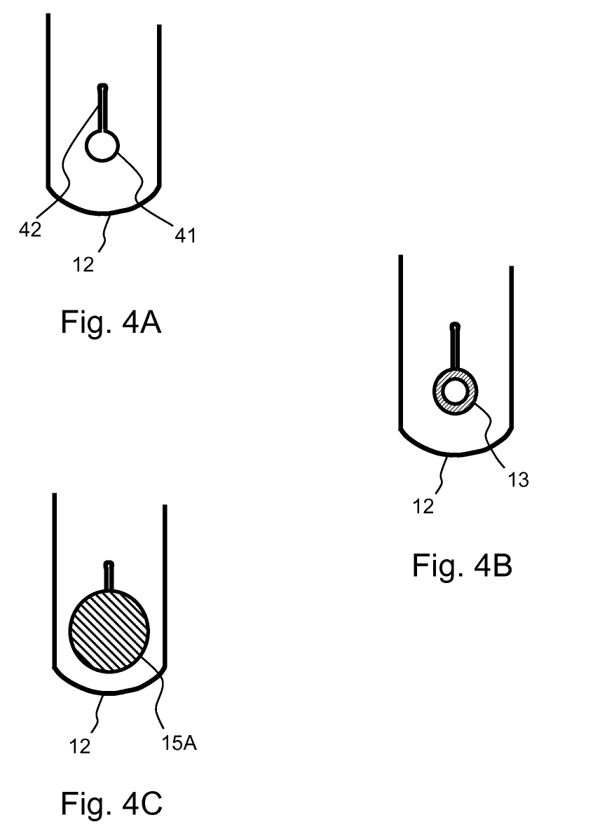

FIG. 4A shows a typical strap 12 with a hole 41 and slot opening 42. The diameter of the hole 41 is typically a little smaller than the diameter of a typical end pin jack shoulder. The slot opening 41 allows a user to manipulate the total opening size of the hole 41 and slot opening 41 to allow the strap 12 to be placed over the shoulder of an end pin.

FIG. 4B shows the typical strap 12 affixed onto a typical end pin jack 13 with no electrical plug mated with the end pin jack 13. Once the strap 12 is in place on the end pin, the smaller diameter of the hole 41 of FIG. 4A prevents the strap from easily coming off of the end pin jack. With a period of use of strap 12, including period removal and reinstallation over an end pin jack, the total opening of the hole 41 of FIG. 4A and slot opening 42 of FIG. 4A combined can become distorted and enlarged thus making it easier for the strap 12 to inadvertently come off of the end pin jack 13.

FIG. 4C shows the typical strap 12 and further shows the head 15A of the present invention which is mated with the end pin jack 13 of FIG. 4B in place of an electrical plug. The size of the head 15A of the present invention is sufficiently large to prevent even a worn and distorted strap opening from coming completely off. A head 15A with a typical diameter of ⅝ inch is generally sufficient to prevent unwanted removal of the strap 12, but the size and shape of the head 15A can vary greatly.

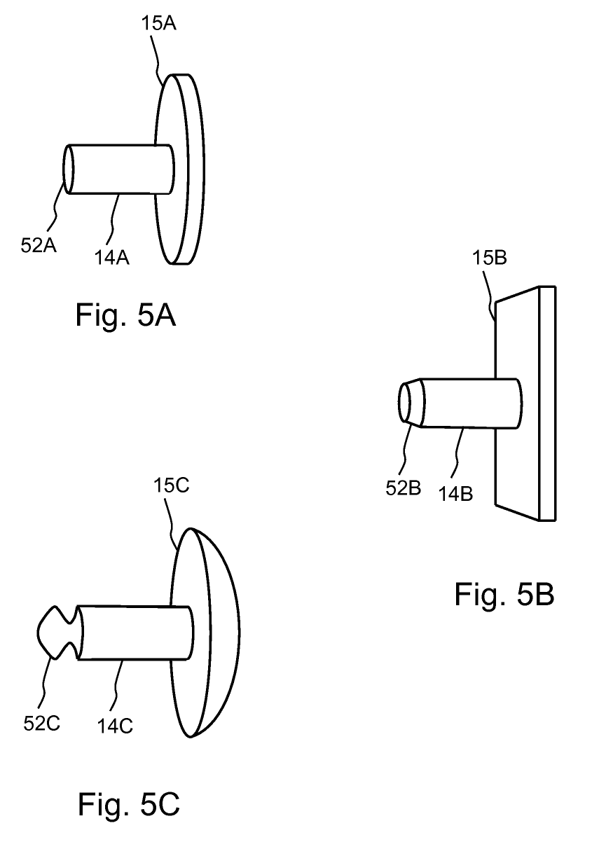

FIG. 5A shows one simple embodiment of the present invention. The present invention has a shaft 14A affixed to a head 15A. The shaft 14A has a free end tip 52A at the end opposite from the end of the shaft 14A which is affixed to the head 15A. In this embodiment, the head 15A has a flat disc shape and the shaft 14A is a simple cylinder with a flat tip 52A. The diameter of the shaft 14A must allow it to be inserted into an end pin jack in place of an electrical plug. For a typical ¼ inch type of end pin jack, a shaft 14A diameter of about ¼ inch and a shaft 14A length of about ⅝ inch works well, though both dimensions can vary significantly. A head 15A with a diameter of about ⅝ inch and a thickness of about ¼ inch works well, but both dimensions can vary significantly. For end pin jacks other than the ¼ inch variety, such as 3.5 mm or 2.5 mm, the dimensions of the shaft should be adjusted accordingly.

FIG. 5B shows another embodiment of the present invention, this one with a square head 15B and a tapered tip 52B. A tapered tip 52B can make insertion of the invention into an end pin jack easier. The size and shape of the head 15A 15B 15C can vary greatly and could include decorative elements such as logos or functional elements such as a pick holder.

FIG. 5C shows another embodiment of the present invention, this one with a shaft tip 14C which replicates the typical shape of the tip of an electrical plug. By replicating the shape of an electrical plug, the shaft is more strongly retained in the end pin jack by the normal electrical jack mechanism. The head 15C has a convex disc shape.

There are numerous other methods that can be used to increase the retention of the shaft 14A 14B 14C. For example the shaft could use the “banana plug” shape disclosed in U.S. Pat. No. 2,032,847 to Klienmann et. al. (1936) and which has been used in many variations since.

For the various embodiments, the shaft 14A 14B 14C and the head 15A 15B 15C and tip 52A 52B 52C can be made of any number of materials, including materials which are rigid (such as wood, metal, or some plastics) or somewhat flexible (such as some plastics or leather) or some combination of such materials.

Some key advantages of the present invention are: it is a very simple device which is easily and cheaply manufactured and which is effective in preventing the inadvertent removal of a support strap from and end pin jack during the most vulnerable period, namely while the electrical plug is not mated. The present invention does not easily come accidentally dislodged or removed like some prior art. The present invention does not depend upon the exact outer dimensions of the end pin jack or its shoulder, like some prior art. The present invention depends only upon the electrical jack portion of the end pin jack conforming to a standard size specification, which is highly likely to be the case. There are numerous well-tested shaft shapes and tip shapes that have been proven to be effective at being retained in such a jack.

Many examples of prior art exist which require modifying, adapting, or adding to the strap. The present invention does not require any of those preparations. There are also a few examples of prior art which do not require such preparations, but those examples of prior art have other weaknesses, such as depending upon the exact outer dimensions of the end pin jack. In some case the prior art is an improvement over the absence of any restraining method but the prior art is still subject to being inadvertently removed. The present invention avoids those weaknesses.

The present invention can be practiced in a number of different embodiments. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

I claim:

1. An apparatus for restraining a strap on an end pin jack comprising:
a head of a diameter larger than the opening in the strap; and
a shaft with two ends wherein one end is affixed to the head and the other end is a free end available for insertion into the end pin jack.

2. The apparatus of claim 1 wherein the head is approximately disc shaped.

3. The apparatus of claim 1 wherein the free end tip is approximately flat.

4. The apparatus of claim 1 wherein the free end tip is tapered.

5. The apparatus of claim 1 wherein the free end tip is shaped approximately like the tip of an audio plug.

6. The apparatus of claim 2 wherein the free end tip is approximately flat.

7. The apparatus of claim 2 wherein the free end tip is tapered.

8. The apparatus of claim 2 wherein the free end tip is shaped approximately like the tip of an audio plug.
